(19) United States
(12) Patent Application Publication
(10) Pub. No.: US 2004/0205575 A1
(43) Pub. Date: Oct. 14, 2004

(54) Method and system for incorporating a value in a document

(76) Inventor: Martin Wattenberg, Wellsley, MA (US)

Correspondence Address: KENYON & KENYON, ONE BROADWAY, NEW YORK, NY, 10004, US

(21) Appl. No.: 10/121,923

(22) Filed: Apr. 12, 2002

Related U.S. Application Data
(60) Provisional application No. 60/283,790, filed on Apr. 12, 2001.

(51) Int. Cl. G06F 15/00; G06F 17/00; G06F 17/21; G06F 17/24; G09G 5/00

(52) U.S. Cl. 715/513; 345/760

(57) ABSTRACT

A method and a system for the visualization and/or vocalization, including for example, the incorporation by audio, of quantitative information about a document (e.g., a Web page) that may also reflect spatial pattern information. The present invention may operate with Web pages and other electronic documents over an information network such as the Internet. Alternative embodiments of the present invention may not need to operate with documents over an information network. According to the example embodiment, a target document (e.g., a Web page) is retrieved and a copy or snapshot may be made. Quantitative data is also obtained for the target document reflecting the quantitative metric to be visualized and/or vocalized. A scale for the quantitative data may be generated and used to assign data visualization and/or vocalization values. The copy or snapshot of the target document may then be altered to reflect the data visualization and/or vocalization of the quantitative metric according to the example embodiment of the present invention. For example, the data visualization and/or vocalization may include the use of color and/or brightness to reflect a quantitative metric such as the click through rate for hyperlinks on a Web page. Additional software may be used according to the example embodiment of the present invention and may include two Java programs: one Java program for making a copy or snapshot of the target document, and a second Java program for the data visualization and/or vocalization. In alternative embodiments of the present invention, a copy or snapshot of the target document is not used.

### FIELD OF THE INVENTION

The present invention relates to a system and method for incorporating a value in a document such as a Web page.

### BACKGROUND INFORMATION

The Internet and the World Wide Web (“Web”) have become an integral means of communication within our society. Individuals all over the world search the Web for information posted by other individuals, corporations, churches, political organizations, and others. This Web-based information is located at Web sites containing one or more Web pages, each a window of information. A Web page is defined by a markup language document containing instructions on what information is contained in the Web page, where to get the information (if necessary), and how to display it. A Web site operator will often track certain statistics regarding user interaction at their Web site and Web pages in order to improve the effectiveness of their presentation. These statistics may relate to the specific information elements (hereinafter referred to objects) specified in the markup language document or to the components of these objects (hereinafter referred to as components). These statistics may be gathered in a number of ways but are usually provided by the local Web server on which a Web site is hosted.

Statistics on Web pages, especially statistics regarding Web traffic analysis, are typically reported in a textual manner and may occasionally include some graphical illustration. For example, statistical traffic analysis reporting provided by a local Web server to a Web site operator may include a list of Web page links ordered by popularity. The Web site operator would then laboriously match up the numbers in that analysis with the links in the page. FIG. 1 is an illustration of a sample report indicating Web traffic. FIG. 1 is indicative of how a Web site operator may have to match up reported numbers with links in a Web page. This process can be difficult to manage and often does not address an underlying problem for Web site operators and designers: namely, the understanding of how users navigate through their Web pages.

Web traffic statistics provide only limited information about how users navigate through a Web site. In particular, conventional Web traffic statistics provide limited information about the spatial patterns of user navigation. Spatial patterns of navigation relate to how users interact with objects, components, and/or hyperlinks placed in different areas or regions of the Web page-essentially the geography of a Web page. These spatial patterns of navigation may be very important to optimizing Web page design and improving the overall performance of a Web site (and its associated Web pages). The easiest method of providing this spatial pattern information is through a visual display of the underlying statistical information. Conventional reporting and display of information relating to a Web site makes only limited use of Web-accessible visualization about how users interact with the Web site (i.e., the human-computer interaction).

One conventional reporting and display method is a Bell Labs' project conducted by Doree Duncan Seligman, Stephan Vladimir Bugaj, and Cati Laporte called “Live Web Stationery”. Bell Labs Presents New Virtual Reality Environment at SIGGRAPH '97 (Aug. 6, 1997) <http://www.bell-labs.com/news/1997/august/6/1.html>; http://www.metaphorium.com/metaphorium/LWS/SIG97-TS.html. The Live Web Stationery project involved aging a Web page to reflect the amount of “handling” or traffic that it received. This aging process occurred in a manner similar to that of real paper with alterations to the “paper” (i.e., the Web page) texture and shape based on specifically developed algorithms reflecting the stress of “human handling” on the Web page. Additionally, the Live Web Stationery project showed the popularity of links on the Web page by using playful images such as thumbprints and coffee stains. The Live Web Stationery effects were intended for the end-user (i.e., the audience of the Web page) and not the Web site operator or developer. Additionally, the effects generated by Live Web Stationery were accomplished, in general, by adding images to the Web page (e.g., the thumbprints and coffee stains) and did not involve altering existing images, objects, and/or components except for changes to the page textures and backgrounds. Perhaps most significantly, the effects of Live Web Stationery did not reflect a visually discernible quantitative analysis of the Web traffic to the particular links, components, and/or objects on the Web page.

The Live Web Stationery project, though a useful tool for the end-user to show the effects of Web page “handling”, did not address the needs of Web site operators and designers for the visualization of Web page quantitative information such as Web traffic statistics. Live Web Stationery also did not provide the spatial pattern information regarding the quantitative values that is particularly useful in analyzing Web page quantitative information.

### SUMMARY

The present invention provides a method and system for the visualization and/or vocalization, including, for example, the incorporation by audio, of quantitative information about a document (e.g., a Web page) that may also reflect spatial pattern information. The present invention relates to electronic documents in general and not necessarily Web pages, though the Internet Web context is the principle embodiment discussed herein. For example, the present invention may be implemented in conjunction with a database application program using database report screens or data inputs. In another example, the present invention may operate with a file system navigation program or use file system navigation program screens. Additionally, the present invention may operate in conjunction with, over, or separate from an information network such as the Internet and is not therefore dependent on a connection to or existence of an information network. For example, the present invention may be implemented through a local software program installed on a local computer that is independent of any possible attached information or communication network. This local software program may be a stand-alone program or may be a plugin, control, applet, script, helper application, or other such segment of software code used to augment another stand-alone software application (i.e., program). For example, the present invention may be implemented as an ActiveX control, which may work with any ActiveX enabled application whether or not the application is network dependent.

In accordance with the example embodiment of the present invention, two Java programs are used in a Web-based context. The first Java program may make a copy or take a snapshot of a document (i.e., a Web page) to be used. The copy or snapshot may be made at a particular time specified by the user. The second Java program may combine data from a server log file and/or other quantitative data source with the copy or snapshot of the Web page saved by the first Java program. The output of the second Java program, according to the example embodiment, may be one or more markup language files (e.g., HTML files) and/or images that may be viewed in any standard Web browser.

The present invention may operate with quantitative information representing a number of discernible statistics or values. For example, in one embodiment of the present invention, a click through value indicating the number (actual or logarithmic) of user mouse clicks on a hyperlink (such as a hypertext link or hyperlink associated with a banner, button, image, or graphical icon) may serve as the type of quantitative data visualized and/or vocalized in the respective document. In another example embodiment of the present invention, the average (per user visit or per session) or total (actual or logarithmic) of user mouse rollover events (i.e., passing the cursor controlled by a mouse or other pointing device) over a hyperlink (as previously mentioned such as a hypertext link or hyperlink associated with a banner, button, image, or graphical icon) may serve as the type of quantitative data visualized and/or vocalized in the respective document. In a third example embodiment, an algorithmic determination of the school grade-level complexity of a word and/or sentence (e.g., one word and/or sentence may be deemed at the eighth grade level while another at the third grade level) may serve as the type of quantitative data visualized and/or vocalized for a document. According to one embodiment of the present invention, the type of quantitative data used may be predefined or selected by the user in a preferences or option choice selection offered by a program, applet, plugin, control, or other software code involved with the data visualization and/or vocalization. An alternative embodiment of the present invention may allow the user to select the type of quantitative data before each display of data visualization and/or vocalization for a document.

The quantitative information used for the data visualization and/or vocalization may be obtained from a number of conventional sources according to various embodiments of the present invention. For example, in one embodiment of the present invention, the log analysis tools and log file(s) of a local Web server (e.g., the log files of an Apache Web server where the Apache Web server is used to host the Web page) may provide the quantitative information to be visualized and/or vocalized by the present invention. In another example, a log file analysis program may format the log information and provide the input(s) for the data visualization and/or vocalization.

The quantitative information used with a document (e.g., a Web page) may be visualized and/or vocalized in a number of different ways according to various embodiments of the present invention. One embodiment of the present invention may incorporate quantitative information by using a color and/or brightness scale to indicate differences in value. According to this embodiment, the objects and/or components in the document (e.g., a Web page) may be colored according to where their respective quantitative value falls on an overall scale of values. The scale of values may be predetermined or dynamically determined. For example, if a click through measurement is the type of quantitative value (i.e., quantitative metric) being used, a dark to light (black to white) color scale may be used to indicate increased click through rates by increasingly lighter colors. In another example embodiment of the present invention, sound differentiation, for example by volume, tone, or content, may be used to vocalize (i.e., by audio representation) the associated quantitative information such as average mouse rollover rates. The visualization and/or vocalization of the quantitative information may be accomplished by altering the effected objects and/or components in the original document or by generating a counterpart document (e.g., a copy or snapshot of the original document) containing counterpart objects and/or components altered according the quantitative information to be displayed. The present invention may allow, in various embodiments, the customization or selection of the methods and parameters for the visualization and/or vocalization of the quantitative information as well as possibly allowing the selection of the quantitative information to be visualized and/or vocalized.

### BRIEF DESCRIPTION OF THE DRAWINGS

FIG. 1 is an illustration of a sample WebTrends report indicating Web traffic.

FIG. 2 is a block diagram depicting an example of a network topology illustrating the relationship between the Internet, operators, users, a source Web server network node, and a visualization Web server network node according to one embodiment of the present invention.

FIG. 3 is an illustration of a Web page before alterations are made to the display according to one embodiment of the present invention.

FIG. 4 is an illustration of a Web page after alterations are made to reflect the visualization of quantitative data for click through rates on the various objects and/or components contained on the Web page (i.e., within the Web page document) according to one embodiment of the present invention.

### DETAILED DESCRIPTION

The present invention provides a method and system for the visualization and/or vocalization (i.e., audio representation) of quantitative data for a metric (i.e., some quantitative measurement) in a document, such as a Web page. The visualization and/or vocalization of the quantitative data in the document may reflect the spatial patterns of the data in the document. The present invention relates to visualization and/or vocalization of quantitative data in any documents though the particular embodiments described herein relate in particular to Web page documents. For example, the present invention may equally apply, in other embodiments, to non-Web page documents such as, for example, electronic spreadsheets or database related documents including reports and data entry screens. Other alternative documents to Web pages may include, inter alia, the display screens of file system navigation programs.

The present invention does not need to operate in conjunction with an information network though it may, and it does so with the Internet in the example embodiment discussed herein. For example, the data visualization and/or vocalization aspect of the present invention may be implemented through a stand-alone program installed on a local computer that may or may not be connected to an information network. In another example, the data visualization and/or vocalization may be implemented through software code extending the functionality of another software program that is itself not dependent on a connection to an information network. Whether or not an embodiment of the present invention works in conjunction with an information network such as the Internet or is independent of such a network, the data visualization and/or vocalization may be implemented through the use of a stand-alone software program and/or as a plugin, control, applet, script, helper application, or other segment of software code extending the functionality of another software program according to various embodiments of the present invention. For example, the present invention may be implemented using a Netscape Communicator plugin providing this additional functionality to the Netscape Communicator Web browser software.

Process Steps

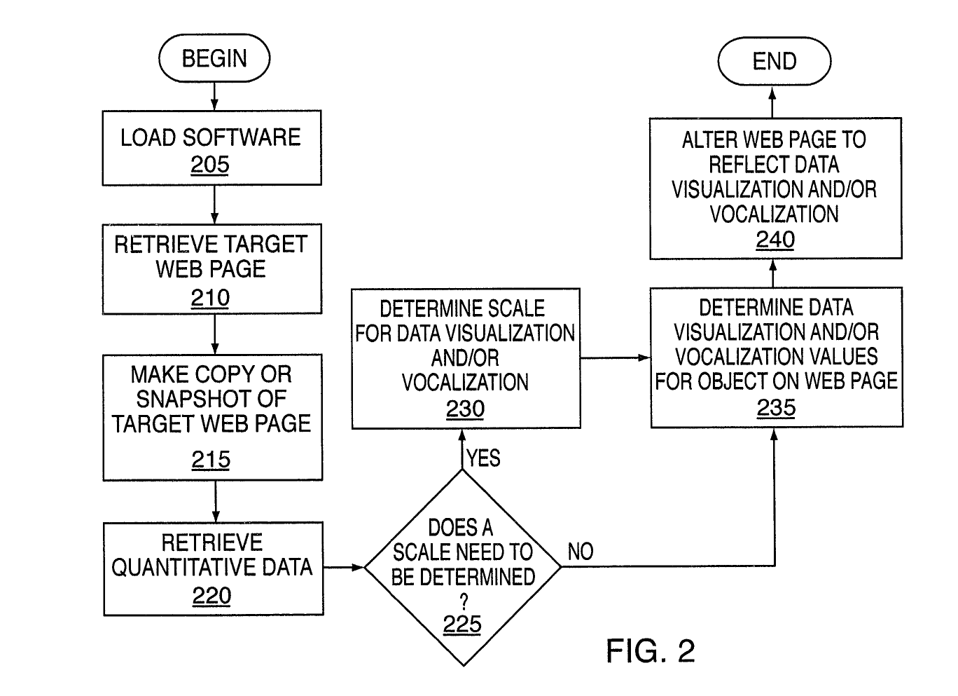

As previously discussed, the data visualization and/or vocalization process may be performed on a variety of documents including an Internet Web page. FIG. 2 is a flowchart outlining an exemplary process for the visualization and/or vocalization of quantitative data for a Web page according to one embodiment of the present invention. In this embodiment, the process begins by loading the software 205. The loading step 205 may entail retrieving all or part of the software from a storage device and loading it into the system memory. The storage device may be attached to a user's computing device or may be a storage device connected to an information network and accessed by the user (i.e., the user's computing device) over the information network. In a Web-based context, the software may include Web browser software that may be needed to access a Web page. The software described herein is used in accordance with the example embodiment of the present invention. A practitioner skilled in the art will recognize that other embodiments of the present invention may greatly vary in the type and quantity of software used.

In accordance with the example embodiment of the present invention, two Java programs may be utilized: one Java program may make a copy or snapshot of a Web page, and the second Java program may perform the data visualization and/or vocalization process.

The capacity to save a copy of a document (e.g., a Web page) at a specified moment may be important because many documents, such as Web pages, may change appearance frequently.

For example, a news Web site and its Web pages may change by the minute and well before the associated server log data may become available. The second Java program may combine data from a server log file with the copy of the Web page saved by the first Java program according to the example embodiment of the present invention. The output of the second Java program may be one or more markup language files (e.g., HTML files) and/or images that may be viewed in any standard Web browser. Although the example embodiment described herein primarily relates to traffic analysis on a Web page, practitioners skilled in the art will recognize that the present invention is compatible with any type of quantity and document, including those documents that are used locally and are not network-based. Once the software is loaded 205, a target Web page is then retrieved 210 according to the embodiment outlined in FIG. 2. Retrieving the target Web page 210 may entail the retrieval of a markup language document which in turn contains commands for loading other objects and/or components on the target Web page. In this case, the initial markup language file, other markup language files, style sheets, objects, and/or components may together form the Web page that is presented to a user. Though this presented Web page is referred to as a document herein, it may be composed of several component documents, objects, and/or components. The retrieval of the target Web page 210 is a conventional process typically handled by a Web browser.

Once the target Web page is retrieved, a copy or snapshot 215 of the Web page may be made at a particular time specified by the user. In this example embodiment, the capacity to save a copy or snapshot 215 of a Web page at a specified moment may be important because many Web sites and Web pages may change by the minute and well before the associated server log data may become available. As discussed earlier, a Java program may be used to make a copy or snapshot 215 of the Web page according to the example embodiment of the present invention. In alternative embodiments of the present invention, a copy or snapshot is not utilized and the existing target Web page or document may be used directly.

The quantitative data associated with the Web page and the objects and/or components on the Web page may also be retrieved 220. The quantitative data may be retrieved from a number of sources (discussed below) and may depend on the type of data visualization and/or vocalization desired by a user. FIG. 2 assumes that the quantitative metric to be visualized and/or vocalized has been preselected or is fixed. In other embodiments of the present invention, the user may determine the quantitative metric to be visualized and/or vocalized. This user determination may effect both the source and the nature of the quantitative data retrieval 220. As previously discussed, a second Java program may be used to retrieve the quantitative data 220 according to the example embodiment of the present invention.

A scale may need to be determined 225 for the quantitative data in order to proceed with the data visualization and/or vocalization. For example, if brightness and color are being used to visualize the click through rate of hyperlinks on a Web page, a scale may be developed 230 using the range of quantitative data retrieved for the Web page (e.g., based on the raw number of click throughs or hits on a hyperlink). According to this example, two different pages may use two different scales because of variations in the quantitative data for those pages. It is also possible, in an alternative embodiment, that a standard scale will be used for a quantitative metric (e.g., based on the percentage of click throughs or hits out of the total number of visitors) and therefore two different pages may use the same scale.

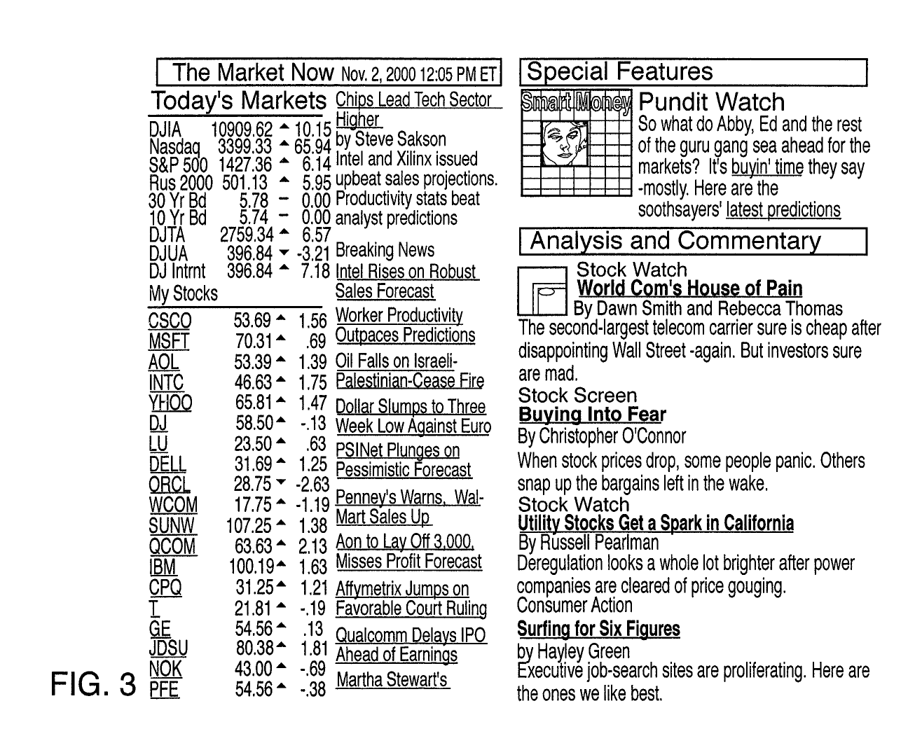

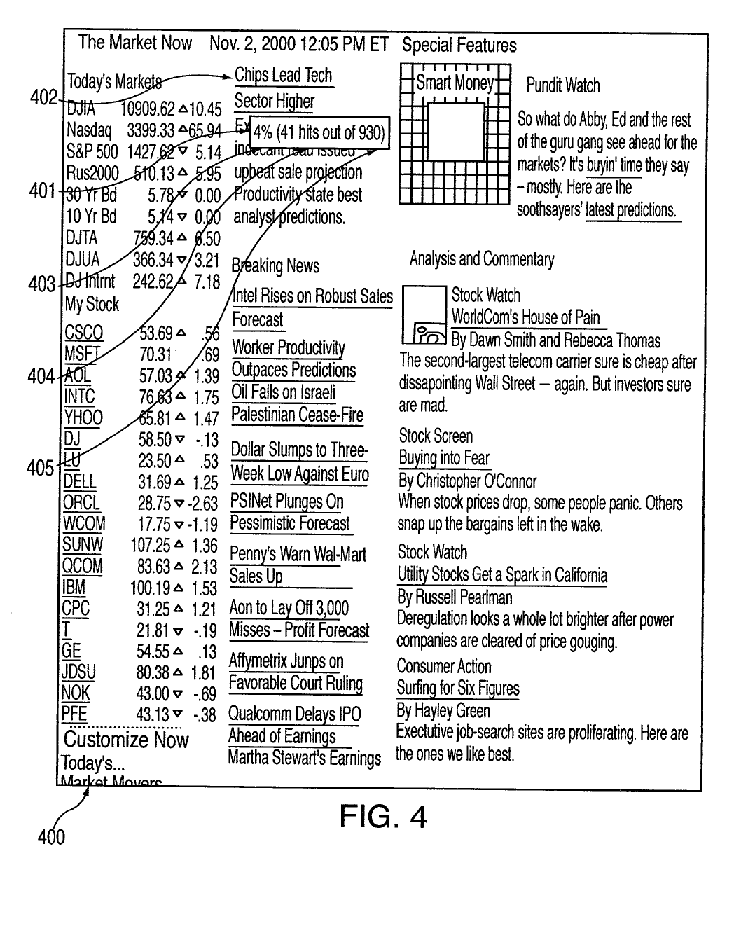

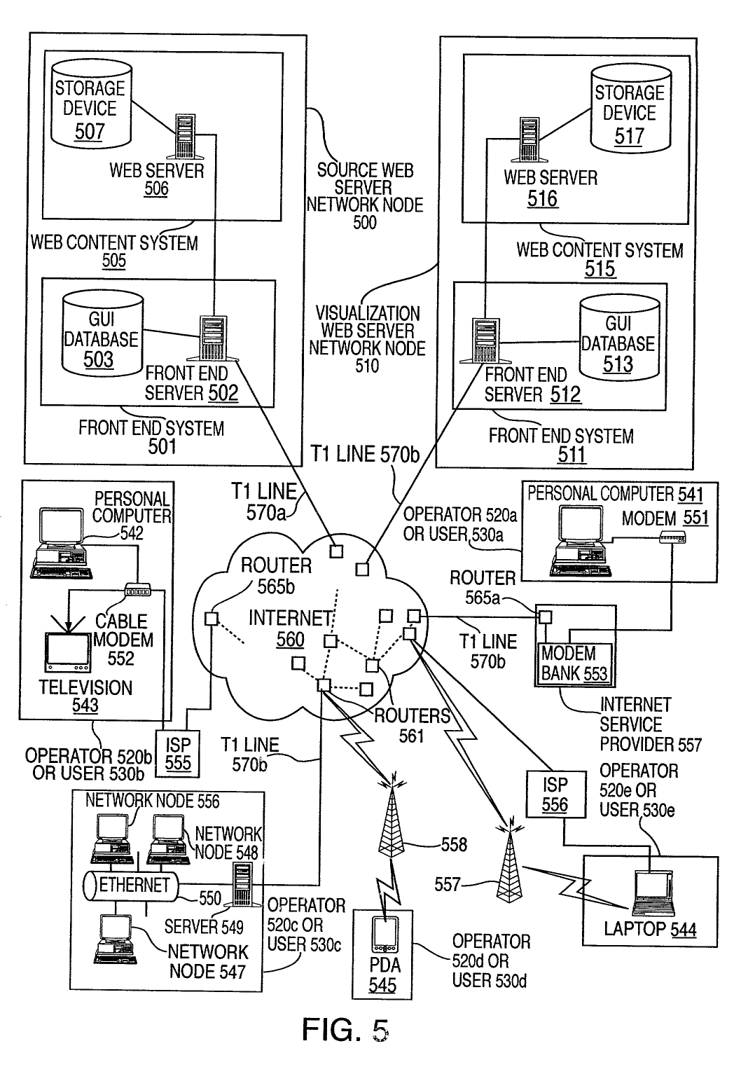

Once the Web page, quantitative data, and scale are available, the data visualization and/or vocalization for each of the effected objects and/or components in the document is determined 235. For example, using the brightness and color data visualization example above for click through rates on hyperlinks, the color and brightness value for each hyperlink is determined. The determined values may be used to alter the copy or snapshot 240 of the Web page so that the data visualization and/or vocalization is possible. In one embodiment shown in FIG. 2, the copy or snapshot of the Web page is altered 240 so that the data visualization and/or vocalization is displayed and/or heard therein. In another embodiment (not shown) a second copy or snapshot of the Web page including the data visualization and/or vocalization values is made so that the user may toggle between a view of the original copy or snapshot and the data visualized and/or vocalized version of the copy or snapshot. In a third embodiment (not shown), the data visualization and/or vocalization values are included in the copy or snapshot of the Web page but are not made available until the user toggles the display of the copy or snapshot. In this third example, each time the user toggles the views, the display of the Web page is recalculated to either include or remove the data visualization and/or vocalization values. The third example is approximately the same as the second example except that it attempts to toggle the display using a single copy or snapshot of the Web page and therefore recalculates the display. In the second example, fixed views of the copy or snapshot of the Web page with and without the data visualization and/or vocalization are available making the toggling of the display easier. In the first example, toggling is not available and only a data visualized and/or vocalized view of the Web page is presented. FIG. 3 is an illustration of a copy or snapshot of a Web page without data visualization and/or vocalization according to one embodiment of the present invention. FIG. 4 is an illustration of a copy or snapshot of a Web page including the data visualization of click through rates on the hyperlinks in the Web page.

System Architecture

FIG. 5 is a block diagram depicting an example of a network topology illustrating the relationship between the Internet, operators, users, a source Web server network node, and a visualization Web server network node according to one embodiment of the present invention. The network topology depicted in FIG. 5 relates to an embodiment of the present invention where the data visualization and/or vocalization software may be located at another network node, in this case the visualization Web server network node 510, and may be made available to a user for downloading to their local computing device. In other embodiments of the present invention, the data visualization and/or vocalization software may be distributed by other means and, therefore, no need for a visualization Web server network node 510, as shown in FIG. 5, may exist. As shown in FIG. 5, the source Web server network node 500 and visualization Web server network node 510 may make available one or more Web sites which operators 520 and users 530 may visit by connecting to the respective network node. Operators are the designers and maintainers of a Web site such as the source Web server network node 500 and the visualization Web server network node 510 while the users referred to in FIG. 5 are the end-users who access and browse through the Web sites and Web pages on the Internet, such as the Web pages made available by the source Web server network node 500. The term users is used outside this section (i.e., this section on system architecture) to refer to users of the present invention including both the users and operators shown in FIG. 5 and discussed herein.

A Web site is a grouping of one or more associated Web pages sharing a common domain. Each Web page may be defined by a markup language document such as, for example, a HyperText Markup Language (“HTML”) or eXtensible Markup Language (“XML”) document. The markup language document may contain instructions and references to objects and/or components (used herein to describe, for example, the text, images, hyperlinks, banner advertisements, and buttons that are displayed on the Web page) that are interpreted by a Web browser to provide a display of information to a user. Components may be objects in their own right or may be portions of an object such as a figure or element of a drawing and/or a portion of chart (e.g., a slice in a pie chart). When a operator 520 or user 530 accesses a Web page, the markup language document may be transmitted to the operator 520 or user 530 over an information network such as the Internet 560 if a locally stored or cached version of the Web page is not available.

Operators 520a-520e and users 530a-530e are coupled to the source Web server network node 500 and the visualization Web server network node 510 via an information network such as the Internet 560. Operator 520a and user 530a illustrate an example of a typical narrowband client connected to the Internet 560 via a dial-up connection. Operator 520a and user 530a utilize a personal computer 541 and a modem 551 to access ISP 557 and navigate the Web 560 via Web browser software (not shown). The Web browser software permits navigation between various Web document servers connected to the Internet 560, that may include the front end server 502 at source Web server network node 500 and the front end server 512 at visualization Web server network node 510. In addition to assisting with navigation between Web servers, the Web browser software interprets the markup language codes contained within Web documents (i.e., Web pages) and provides functionality for the rendering of files distributed over the Internet (e.g., through the use of plugins or ActiveX controls).

Operator 520b and user 530b illustrate an example of a typical broadband client connected to the Internet 560 via a cable connection. Operator 520b and user 530b utilize a personal computer 542 and a cable mode 552 to access ISP 555 via the cable connection and navigate the Web 560 via Web browser software (not shown). Operator 520c and User 530c illustrate an example of a typical broadband corporate client with internal network nodes 546-548 which are coupled to the Web and Internet 560 via a local Ethernet network 550, server 549, and T1 line 570c of the corporate client. Internal Ethernet network nodes 546-548 may also use Web browser software (not shown) to navigate the Web 560. Operator 520d and user 530d illustrate an example of a narrowband client using a personal digital assistant (“PDA”) 545 to connect to the Internet 560 via a wireless connection 558. Operator 520e and user 530e illustrate an example of a narrowband or broadband client using a laptop 544 to connect to the Internet 560 by either a wireless connection 557 or land line connection to an ISP 556. Operators 520d-520e and users 530d-530e may also use Web browser software (not shown) to navigate the Web 560. Although FIG. 5 illustrates five example operators 520a-520e and users 530a-530e, it is to be understood that source Web server network node 500 and visualization Web server network node 510 may serve any arbitrary number of operators 520 and users 530 limited only by the processing power and bandwidth available.

Types of Quantitative Data

In various embodiments, the present invention may reflect all types of quantifiable data concerning a Web page, the components, and/or the objects on the Web page. In one embodiment of the present invention, Web traffic analysis data is the quantifiable data visualized and/or vocalized for the document. Web traffic analysis may include information about how frequently users click on various objects and/or components of the Web page. For example, the number (i.e., the raw or logarithmic value) of users grouped by domain who have clicked on a particular hyperlink (e.g., a hypertext link or hyperlink associated with a banner, button, image, or graphical icon) may serve as the quantitative Web traffic analysis data visualized and/or vocalized for the respective document. In another example, the number (actual or logarithmic) of times that users highlight text on a page may serve as the quantitative data for the visualization and/or vocalization performed by the present invention. In another embodiment of the present invention, a total or average number (displayed as a raw or logarithmic value) of mouse rollover events for an object and/or component may serve as the quantitative data used in the visualization and/or vocalization process.

In other embodiments of the present invention, data other than Web traffic analysis data may be used as the quantifiable data visualized and/or vocalized by the present invention. For example, a search engine could mark words and/or images in a returned Web page according to the degree of relevance to the search. In another example, a Web page or other document could be marked to indicate the grade-level difficulty of words. This example use could be used by a teacher or others to determine the grade-level difficulty of a document or of any passages within a document.

Source of Quantitative Data

The quantitative data used to alter the display of a Web page as part of the data visualization and/or vocalization process may be obtained from a number of sources according to various embodiments of the present invention. In the example embodiment of the present invention, the quantitative data may come from the log analysis tools of the local Web server on which the Web site and its Web pages are hosted. For example, if the local Web server is an Apache Web server, the Apache Web server log files may contain the quantitative data used for the data visualization and/or vocalization. According to another embodiment of the present invention, the quantitative data may come from a program that runs on the Web server and is not part of the Web server's log analysis tools.

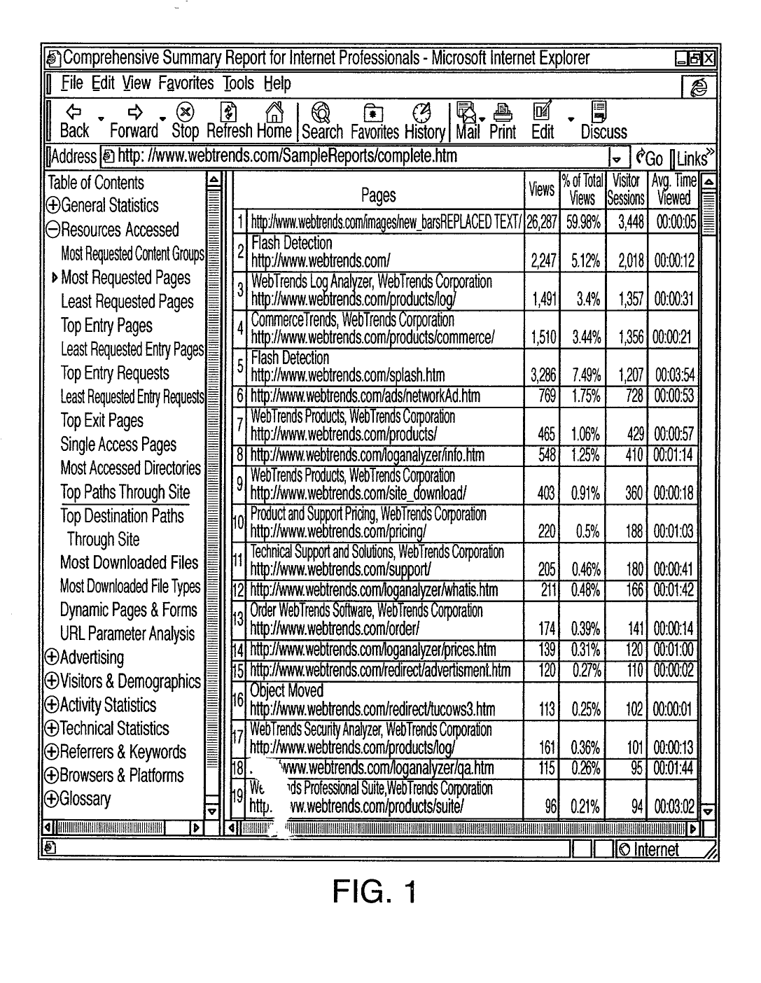

The actual data logged by a conventional Web server log file can be arcane; thus, a log file analysis program may be used to make sense of the information contained therein. There are a number of log file analysis programs that analyze the data within the log file and generate easy to read reports concerning the logged data. For example, WebTrends Log Analyzer (i.e., the Log Analyzer product of WebTrends Corporation) provides information about a Web site and its Web pages and about the users who visit them. FIG. 1 illustrates an example of the types of information that may be supplied in a WebTrends report. WebTrends reports may include statistical information and colorful graphs showing usage and trends among other information. The information tracked by WebTrends and other log file analysis programs may include information about how users are referred to the Web site and their activities at the Web site. The log file analysis program reports may be generated as HTML or XML documents which a user may browse over the Web or they may be generated in a number of other formats such as, for example, Microsoft Word. The report data may also be placed in a comma-delimited file which can then be read by another software application. In the example embodiment of the present invention, log data may be obtained from server logs imported to a client computer (i.e., a computer connected to the server) using FTP (file transfer protocol). In other embodiments of the present invention, log data may be obtained from a database or data file generated by different log analysis programs.

In one embodiment of the present invention, a log file analysis program examines the Web server log files and generates a comma-delimited file(s) containing the quantitative data used in accordance with an example embodiment of the present invention. For example, WebTrends Log Analyzer may be used to generate a comma-delimited file containing the traffic data (e.g., click throughs or hits) on the particular Web page hyperlinks (i.e., points on the document identified by text, banner advertisements, or other graphical icon, image, or image component that, when clicked on by a user, result in the Web browser calling another Web page, object, and/or component). According to one embodiment of the present invention, this comma-delimited file may be created in a particular location (e.g., folder) within the Web server directory structure and may have a predetermined filename both of which may be used to locate and identify the source file containing the quantitative data. In this embodiment, the quantitative data file is automatically searched for and loaded, and the information contained therein is used to provide a visualization and/or vocalization of the quantitative data values to the user. In another embodiment of the present invention, the quantitative data source file is not automatically loaded and processed and at least one manual step is processed to prepare the information for use. For example, this manual step may include manually keying (e.g., entering by means of a keyboard) the values for use.

Data Visualization and/or Vocalization

In one embodiment of the present invention, the underlying values are visualized using colors and/or brightness (brightness may, in one embodiment, be expressed as differences in color) to reflect the differences in a value for a particular statistic (i.e., type of quantitative value). In one example where the statistic is how frequently a link is followed (i.e., click through rate or hit rate on the hyperlink), a brighter or lighter shade of color for the link may indicate a more frequently followed link while a darker link may reflect a less frequently followed link. According to this embodiment where color or brightness are used to differentiate the values visualized on the document, the quantitative data is used to calculate a range of values which is then mapped to a color/brightness scale on which each value has an associated color or brightness. Using the click through rate as the type of quantitative data visualized and/or vocalized, if a Web page has three links the first receiving 100 hits, the second 1000 hits and the third 10,000 hits, a range may be calculated and the values applied to the range using a mapping algorithm (which may use logarithmic values according to one embodiment of the present invention) in order to determine the color (in this example) associated with each value. For example, link one may be black while link two may be blue and link three may be white each indicating a different color along the color spectrum. In another example, a variance may be calculated for the traffic at each link. This calculated variance may serve as the value used for the data visualization and/or vocalization. For example, the links may be altered by an attribute such as color to reflect differences in the variance of each link. A practitioner skilled in the art will recognize that any value that may be received or calculated for objects and/or components in the document may be used to generate a range of values (reflecting differences in the values) for the data visualization and/or vocalization.

Differences in the visualization and/or vocalization values for the objects and/or components on a Web page may be shown using some distinguishing visual or audio characteristic, i.e., attributes of the objects and/or components. In one embodiment of the present invention, the distinguishing characteristic may be color or brightness. In another embodiment of the present invention, effects such as the rate of blinking may be used to distinguish the values. Other embodiments of the present invention may include textures, patterns, shading, fonts, sounds, and other effects or additional media to distinguish the underlying values for the data visualization and/or vocalization. Customization of the Displayed Data Visualization and/or Vocalization According to one embodiment of the present invention, the method of data visualization and/or vocalization may be customized by the user. In one such embodiment, the user may specify preferences as to how the user wants to see the information presented. This preference information may be used for a single data visualization and/or vocalization of a Web page or the preference information may be stored for future use in the data visualization and/or vocalization of other Web pages. In another embodiment, the user may customize the displayed data visualization and/or vocalization by selecting particular options that result in a reconfiguration of the currently displayed values. For example, if a data visualization and/or vocalization of a Web page displays to user the underlying Web traffic values of the hyperlinks by using color to distinguish the various values, the user may select a pull-down menu option provided in one embodiment of the present invention to alter the distinguishing characteristic from color to some other characteristic such as blink rate. This example may result in a change from a distinguishing color display from dark-to-bright colors identifying low-to-high user traffic to a distinguishing blinking display where slow blinking-to-fast blinking identifies low-to-high user traffic at the hyperlink.

Web Page Copy or Snapshot

The process of displaying the data visualization and/or vocalization of quantitative data for a document such as a Web page may involve the making of a copy or snapshot of the document according to one embodiment of the present invention. This copy or snapshot may be made at a specific time and may be helpful particularly with a Web page or other documents that tend to change frequently. The copy or snapshot may be particularly useful in data visualization and/or vocalization where the user is provided the ability to toggle from a normal view of the copy or snapshot to the data visualized and/or vocalized view of the Web page. For example, in one embodiment where no toggling capability exists, the copy or snapshot may be altered directly so that the data visualization and/or vocalization values are displayed and/or heard therein. In an embodiment where toggling is provided, a second copy or snapshot of the Web page altered to reflect the data visualized and/or vocalized view of the page may be used. In a third embodiment also where toggling is provided, the copy or snapshot may include the data visualization and/or vocalization values but the Web page altered data visualized and/or vocalized display is not made available until the user toggles the display. In this third example, each time the user toggles the display, the display of the Web page is recalculated to either include or remove the data visualization and/or vocalization values. The third example is approximately the same as the second example except that it attempts to toggle the display using a single copy or snapshot of the Web page and therefore requires recalculating the display. In the second example, fixed views of the copy or snapshot of the Web page with and without the data visualization and/or vocalization are available making the toggling of the display easier. In the first example, toggling is not available and only a data visualized and/or vocalized view of the Web page is presented.

FIG. 3 is an illustration of a Web page before alterations are made to the display according to one embodiment of the present invention. FIG. 4 is an illustration of a Web page after alterations are made to reflect the visualization of quantitative data for click through rates according to one embodiment of the present invention. In fact, FIG. 4 illustrates the same Web page as shown in FIG. 3 after alterations are made for the visualization of click through data for the various objects and/or components (i.e., hyperlinks) contained on the Web page (i.e., within the Web page document). In various embodiments of the present invention, a pop-up box may be used with each object and/or component on a document that is effected by the data visualization and/or vocalization process (i.e., for which quantitative data has been retrieved as part of the data visualization and/or vocalization process). The pop-up box may be used to supplement the data visualization and/or vocalization in order to provide a more exact presentation of quantitative information. For example, the pop-up box 401 on the visualization page 400 refers to a hyperlink 402 for an article entitled “Chips Lead Tech Sector Higher”. The data in the pop-up box 401 indicates the click through percentage 403 (i.e., “4%”) based on the number of click throughs or hits 404 (i.e., “41”) out of the total number of people 405 who have viewed the Web page during a given period of time (i.e., “930”). The text box information is included in one embodiment of the present invention to supplement the data visualization on the Web page where higher click through rates are represented by brighter and different color Web page objects and/or components, in this case hyperlinks. In the example shown in FIG. 4, the color and brightness of the example Web page object and/or component, the hyperlink 402 for an article entitled “Chips Lead Tech Sector Higher”, has a hex value of “EEFFEE”. In alternative embodiments of the present invention, a text box may not be used.

In one embodiment of the present invention, quantitative data may be cached with the copy or snapshot of the Web page (e.g., FIG. 3) or with a data visualized and/or vocalized view of the Web page (e.g., FIG. 4). For example, as shown in FIG. 4, hit-count or click through data may be stored in the copy or snapshot of the Web page in the form of pop-up text that is displayed when the user moves the mouse over a hyperlink. The information may also be stored in other ways such as, for example, in charts and graphs or as raw numerical data appended to the Web page document (e.g., the HTML file).

The copy or snapshot of the document (e.g., the Web page) may contain some or all of the objects and/or components (including the hyperlinks) in the original document (e.g., the target Web page) according to one embodiment of the present invention. An object and/or component contained in the copy or snapshot may be placed in a position that corresponds to the position the respective object and/or component is located on the original document. Using the same corresponding location may allow the spatial patterns of data to be more apparent. In another embodiment of the present invention, an object and/or component contained in the copy or snapshot of a document may be in the same relative position as the respective object and/or component on the original document. In this embodiment, the location of an object and/or component in the copy or snapshot does not need to correspond to the actual location of the respective object and/or component on the original document but may be in the same vicinity. In a third embodiment, the location of an object and/or component in the copy or snapshot does not need to correspond or relate to the respective object and/or component position in the original document. This third embodiment may be useful where reorganizing the presentation of the objects and/or components is beneficial even though the spatial patterns of the data may not be as readily discernible.

In an alternative embodiment of the present invention, a copy or snapshot of the document is not made and the data visualization and/or vocalization may be applied dynamically to the document (e.g., the Web page). As explained earlier, problems with a lag in log file data may make this alternative embodiment more difficult to use with frequently changing documents such as stock quotation and news Web pages.

Local Version of Document

In one embodiment of the present invention, a copy or snapshot may not be necessary because a local version of the document may exist that can be used. For example, when a user accesses a target Web page, a local version of the Web page different from the original is usually placed in a cache on the local computing device. If a local version of a document other than the original document exists, it may be used as the copy or snapshot. In the local version, the location of objects and/or components may or may not correspond to those of the objects and/or components in the original document.

Select Objects/Components in the Copy or Snapshot

A copy or snapshot of a document may also include select objects and/or components from the original document according to one alternative embodiment of the present invention. For example, a copy or snapshot of a target Web page may include only the hyperlinks from the target Web page. In this example, as previously discussed, the hyperlinks in the copy or snapshot may corresponds to the location of the respective hyperlinks in the target Web page, may be in the same relative position as the respective hyperlinks in the target Web page, or may be placed anywhere in the copy or snapshot, such as, for example, in a list of hyperlinks.

Spatial Patterns

The present invention provides a significant advantage over the prior art by providing for the visualization and/or vocalization of quantitative data related to how one or more users interact with a Web site or Web page (or other document). The visualization and/or vocalization of quantitative data not only provides a more readable and useful presentation of information, it accounts for spatial patterns in the data. For example, if the quantitative information visualized and/or vocalized relates to user click through rates on hyperlinks, the visualization and/or vocalization will more easily identify patterns between these click through rates and sections or areas of the document. In a Web page context, this may show the effectiveness or lack of effectiveness in the presentation of certain data. The examples discussed in this specification relate to a limited set of the potential applications of the present invention. A practitioner skilled in the art will recognize that there a number of other possible applications of the present invention.

What is claimed is:

1. A method for representing quantitative data about a document, comprising:
obtaining quantitative data values associated with components of a document, the quantitative data values representing quantitative data for user interaction with the components of the document;
altering a respective attribute of at least two different components of the document, each respective attribute being altered as a function of a different respective one of the quantitative data values; and
displaying, after the altering step, the document.

2. The method according to claim 1, wherein the quantitative data is at least one quantitative metric.

3. The method according to claim 1, wherein the quantitative data is a statistical comparison, the statistical measurement comparing a plurality of components of the document using a standard measurement system for all the compared components.

4. The method according to claim 1, wherein the document is a Web page.

5. The method according to claim 1, wherein the altering step includes altering at least one of a color and a brightness of each respective attribute.

6. The method according to claim 1, wherein the altering step includes altering at least one of a font, a size, a graphics effect, and an audio effect of each respective attribute.

7. The method according to claim 1, wherein the altering step includes altering each respective attribute relative to one another.

8. The method according to claim 1, wherein the obtaining step includes determining at least one of the quantitative data values as a function of user interaction with a hyperlink in the document.

9. The method according to claim 1, wherein the obtaining step includes determining at least one of the quantitative data values as a function of rollover events associated with the components of the document.

10. The method according to claim 1, wherein the altering step includes associating a pop-up box with at least one of the two different components of the document, and wherein the method further comprises:
displaying the pop-up box as a function of interaction with the at least one of the two different components of the document.

11. The method according to claim 1, wherein the at least two different components include alphanumeric characters.

12. The method according to claim 1, wherein the quantitative data includes a count of user click-throughs.

13. The method according to claim 1, wherein the quantitative data is a click-through rate.

14. A method for representing quantitative data about a document, comprising:
obtaining quantitative data values associated with components of a first document, the quantitative data values representing quantitative data for user interaction with the components of the first document;
altering a respective attribute of at least two different components of a second document, each respective attribute being altered as a function of a different respective one of the quantitative data values, each of the at least two different components corresponding to a respective one of the components of the first document; and
displaying, after the altering step, the second document.

15. The method according to claim 14, wherein the quantitative data are quantitative metrics.

16. The method according to claim 14, wherein the quantitative data is a statistical comparison, the statistical measurement comparing a plurality of components using a standard measurement system for all the compared components.

17. The method according to claim 14, wherein at least one of the document, the first document, and the second document is a Web page.

18. The method according to claim 14, wherein the altering step includes altering at least one of a color and a brightness of each respective attribute.

19. The method according to claim 14, wherein the altering step includes altering at least one of a font, a size, a graphics effect, and an audio effect of each respective attribute.

20. The method according to claim 14, wherein the altering step includes altering each respective attribute relative to one another.

21. The method according to claim 14, wherein the obtaining step includes determining at least one of the quantitative data values as a function of user interaction with a hyperlink in the first document.

22. The method according to claim 14, wherein each of the at least two different components of the second document is in a position in the second document that corresponds to a position of the corresponding one of the components of the first document.

23. The method according to claim 14, wherein each of the at least two different components of the second document is in a same relative position in the second document as the corresponding one of the components of the first document is in the first document.

24. The method according to claim 14, wherein the obtaining step includes determining at least one of the quantitative data values as a function of rollover events associated with the corresponding one of the components of the first document.

25. The method according to claim 14, wherein the altering step includes associating a pop-up box with at least one of the two different components of the second document, and wherein the method further comprises:
displaying the pop-up box as a function of interaction with the at least one of the two different components of the second document.

26. The method according to claim 14, further comprising:
making a copy of at least a portion of the first document, the second document being the copy.

27. The method according to claim 14, wherein the first document changes dynamically, the method further comprising:
taking a snapshot of at least a portion of the first document, the second document being the snapshot.

28. The method according to claim 14, wherein the at least two different components include alphanumeric characters.

29. The method according to claim 14, wherein the quantitative data include a count of user click-throughs.

30. The method according to claim 14, wherein the quantitative data is a click-through rate.

31. A method for representing a quantitative value about a document, comprising:
obtaining a quantitative value associated with a hyperlink in a first document, the quantitative value representing a measurement of user interaction with the hyperlink;
selecting at least one of a color and a brightness as a function of the quantitative value;
associating the at least one color and brightness with a component of a second document as a function of the quantitative value, the component of the second document corresponding to the hyperlink; and
displaying, after the associating step, the second document.

32. The method according to claim 31, wherein at least one of the document, the first document, and the second document is a Web page.

33. The method according to claim 31, wherein the component includes alphanumeric characters.

34. The method according to claim 31, wherein the component in the second document is in a same relative position in the second document as the hyperlink is in the first document.

35. The method according to claim 31, wherein the component in the second document is in a position that corresponds to a position of the hyperlink in the first document.

36. The method according to claim 31, wherein the measurement is a count of user click-throughs.

37. The method according to claim 31, wherein the measurement is a click-through rate.

38. A system for representing quantitative data about a document, comprising:
a program memory;
a storage device;
a processor, wherein the processor is adapted to:
(i) obtaining, from the storage device, quantitative data values associated with components of a document, the quantitative data values representing quantitative data for user interaction with the components of the document;
(ii) altering, in the program memory, a respective attribute of at least two different components of the document, each respective attribute being altered as a function of a different respective one of the quantitative data values; and
(iii) displaying, after the altering step, the document.

39. The system according to claim 38, wherein the quantitative data is at least one quantitative metric.

40. The system according to claim 38, wherein the document is a Web page.

41. A system for representing quantitative data about a document, comprising:
a program memory;
a storage device;
a processor, wherein the processor is adapted to:
(i) obtaining, from the storage device, quantitative data values associated with components of a first document, the quantitative data values representing quantitative data for user interaction with the components of the first document;
(ii) altering, in the program memory, a respective attribute of at least two different components of a second document, each respective attribute being altered as a function of a different respective one of the quantitative data values, each of the at least two different components corresponding to one of the components of the first document; and
(iii) displaying, after the altering step, the second document.

42. The system according to claim 41, wherein the quantitative data is at least one quantitative metric.

43. The system according to claim 41, wherein at least one of the document, the first document, and the second document is a Web page.

44. A system for displaying a quantitative value about a document, comprising:
a program memory;
a storage device;
a processor, wherein the processor is adapted to:
(i) obtaining, from the storage device, a quantitative value associated with a hyperlink in a first document, the quantitative value representing a measurement of user interaction with the hyperlink;
(ii) selecting at least one of a color and a brightness as a function of the quantitative value;
(iii) associating, in the program memory, the at least one color and brightness with a component of a second document as a function of the quantitative value, the component of the second document corresponding to the hyperlink; and
(iv) displaying, after the associating step, the second document.

45. The system according to claim 44, wherein at least one of the document, the first document, and the second document is a Web page.

46. A medium storing instruction adapted to be executed by a processor to perform the steps of:
obtaining quantitative data values associated with components of a document, the quantitative data values representing quantitative data for user interaction with the components of the document;
altering a respective attribute of at least two different components of the document, each respective attribute being altered as a function of a different respective one of the quantitative data values; and
displaying, after the altering step, the document.

47. A medium storing instruction adapted to be executed by a processor to perform the steps of:
obtaining quantitative data values associated with components of a first document, the quantitative data values representing quantitative data for user interaction with the components of the first document;
altering a respective attribute of at least two different components of a second document, each respective attribute being altered as a function of a different respective one of the quantitative data values, each of the at least two different components corresponding to one of the components of the first document; and
displaying, after the altering step, the second document.

48. The medium according to claim 47, wherein the quantitative data is at least one quantitative metric.

49. A medium storing instruction adapted to be executed by a processor to perform the steps of:
obtaining a quantitative value associated with a hyperlink in a first document, the quantitative value representing a measurement of user interaction with the hyperlink;
selecting at least one of a color and a brightness as a function of the quantitative value;
associating the at least one color and brightness with a component of a second document as a function of the quantitative value, the component of the second document corresponding to the hyperlink; and
displaying, after the altering step, the second document.
